(19) United States
(12) Patent Application Publication
(10) Pub. No.: US 2019/0340310 A1
(43) Pub. Date: Nov. 7, 2019

(54) AUTOMATIC WATER DISTRIBUTION DESIGN GENERATOR

(71) Applicant: Amit Kumar Saha, Dallas, TX (US)

(72) Inventor: Amit Kumar Saha, Dallas, TX (US)

(21) Appl. No.: 16/167,990

(22) Filed: Oct. 23, 2018

Related U.S. Application Data
(63) Continuation of application No. 62/666,496, filed on May 3, 2018.

(51) Int. Cl. G06F 17/50

(52) U.S. Cl. CPC G06F 17/5004; G06F 2217/34; G06T 2210/04

(57) ABSTRACT

An automatic water distribution design generating system enables those with minimal technical training to obtain complex water distribution designs after receiving the requisite inputs. A portal serves to allow a consumer or contractor to enter data relevant to the area to be watered or other data as needed to properly define the water distribution needs of the area. The portal accesses mathematical or technical equations or the like to develop or generate design for the system and convey the design with the required materials to a contractor.

### BACKGROUND

### 1. Field of the Invention

The present invention relates generally to general contracting systems, and more specifically, to a water distribution installation system for evaluating and adapting the method of distributing water over a landscaped area.

### 2. Description of Related Art

General contracting systems are well known in the art and are effective means to organize and effectuate a construction project. For example, FIG. 1 depicts a conventional sprinkler installation system 101 having a location 103 where irrigation is needed, a customer 105 provides the area and other data relevant to the project to an architect 106 who develops a design that is passed to a general contractor 107. After winning the job the general contractor 107 consults an engineer 109 for specifications for the system then sends parts or the whole installation to a sub-contractor 111. The sub-contractors 111 obtain materials 115 from distributers 112 and suppliers 113 respectively. The sub-contractor 111 and general contractor 107 collaborate to complete job.

One of the problems commonly associated with system 101 is its inherent inefficiencies and limited use. The architect 106 adds significant cost to the system 101. Resulting general contractor 107 or sub-contractor 111 installing the sprinkler or other irrigation system without proper plans. These poorly or unplanned installations are inefficient and water wastage.

Accordingly, although great strides have been made in the area of sprinkler installation systems, many shortcomings remain.

### DESCRIPTION OF THE DRAWINGS

The novel features believed characteristic of the embodiments of the present application are set forth in the appended claims. However, the embodiments themselves, as well as a preferred mode of use, and further objectives and advantages thereof, will best be understood by reference to the following detailed description when read in conjunction with the accompanying drawings, wherein:

FIG. 1 is a diagram of a common sprinkler installation system (Prior Art);

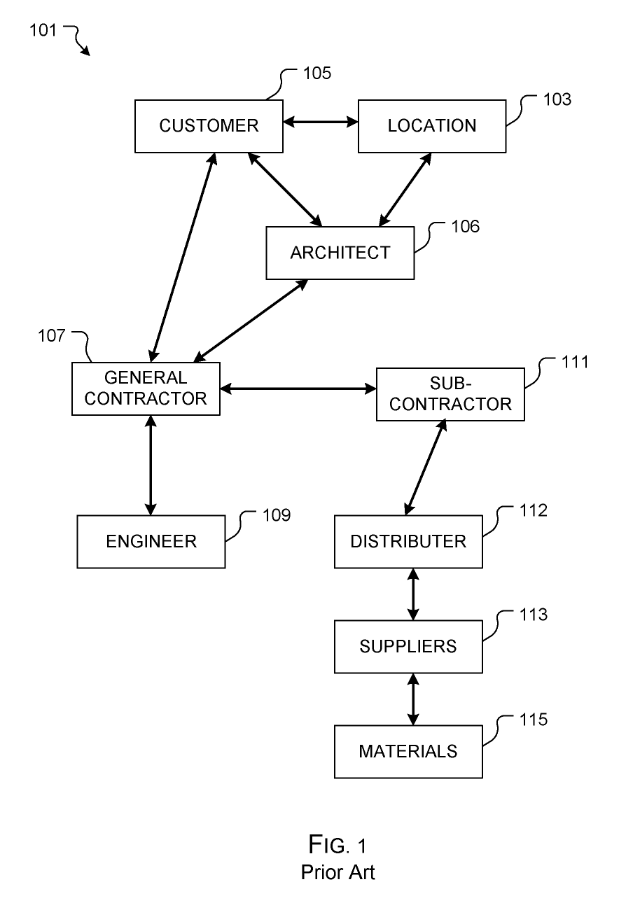

FIG. 2 is a diagram of an automatic water distribution design generating system in accordance with a preferred embodiment of the present application;

FIG. 3 is a flowchart of the preferred method of use of the system of FIG. 2;

FIG. 4 is a diagram of the data types of FIGS. 2 and 3; and

FIG. 5 is a diagram of the portal of FIG. 2

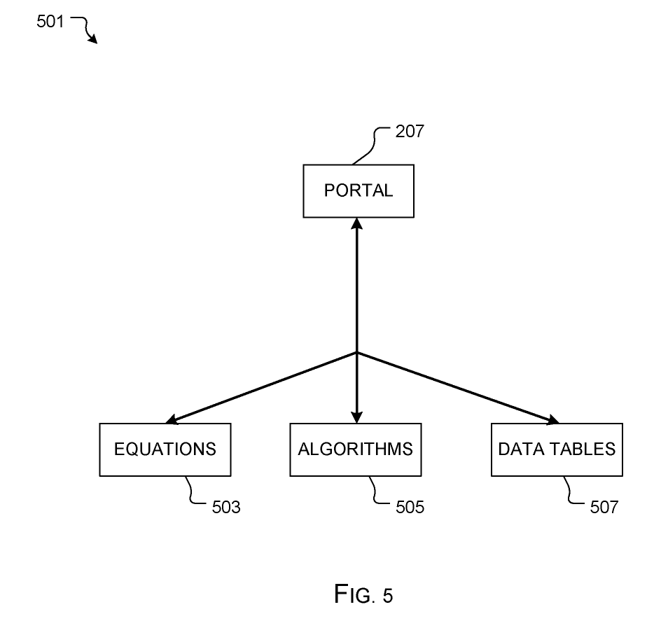

While the system and method of use of the present application is susceptible to various modifications and alternative forms, specific embodiments thereof have been shown by way of example in the drawings and are herein described in detail. It should be understood, however, that the description herein of specific embodiments is not intended to limit the invention to the particular embodiment disclosed, but on the contrary, the intention is to cover all modifications, equivalents, and alternatives falling within the spirit and scope of the present application as defined by the appended claims.

### DETAILED DESCRIPTION OF THE PREFERRED EMBODIMENT

Illustrative embodiments of the system and method of use of the present application are provided below. It will of course be appreciated that in the development of any actual embodiment, numerous implementation-specific decisions will be made to achieve the developer's specific goals, such as compliance with system-related and business-related constraints, which will vary from one implementation to another. Moreover, it will be appreciated that such a development effort might be complex and time-consuming, but would nevertheless be a routine undertaking for those of ordinary skill in the art having the benefit of this disclosure.

The system and method of use in accordance with the present application overcomes one or more of the above-discussed problems commonly associated with conventional sprinkler installation systems. Specifically, the invention of the present application enables those without CAD or engineering training to acquire specification details for the installation of a water distribution system. This and other unique features of the system and method of use are discussed below and illustrated in the accompanying drawings.

The system and method of use will be understood, both as to its structure and operation, from the accompanying drawings, taken in conjunction with the accompanying description. Several embodiments of the system are presented herein. It should be understood that various components, parts, and features of the different embodiments may be combined together and/or interchanged with one another, all of which are within the scope of the present application, even though not all variations and particular embodiments are shown in the drawings. It should also be understood that the mixing and matching of features, elements, and/or functions between various embodiments is expressly contemplated herein so that one of ordinary skill in the art would appreciate from this disclosure that the features, elements, and/or functions of one embodiment may be incorporated into another embodiment as appropriate, unless described otherwise.

The preferred embodiment herein described is not intended to be exhaustive or to limit the invention to the precise form disclosed. It is chosen and described to explain the principles of the invention and its application and practical use to enable others skilled in the art to follow its teachings.

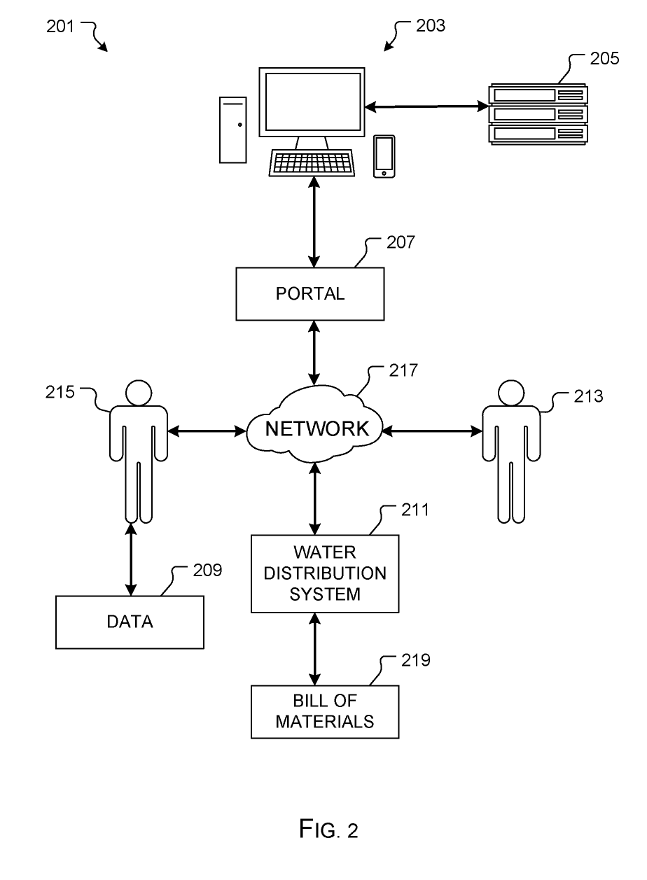

Referring now to the drawings wherein like reference characters identify corresponding or similar elements throughout the several views, FIG. 2 depicts a diagram of an automatic water distribution design generating system in accordance with a preferred embodiment of the present application. It will be appreciated that system 201 overcomes one or more of the above-listed problems commonly associated with conventional sprinkler installation systems.

In the contemplated embodiment, system 201 includes a CPU 203 in communication with a database 205 and a portal 207. It is contemplated that a CPU 203 could be a personal computer, a smart phone, a tablet or any other means of accessing the portal 207. It will also be understood that the database 205 could be storage on the CPU 203, at a remote location, on the cloud or any other method of storing data.

The system 201 also includes a customer 215 with access to the portal 207 via a network 217 to upload data 209 thereto. The output of the system 201 is a water distribution plan 211 along with a corresponding bill of materials 219. A contractor 213 of any level or classification also accesses the portal 207, but to obtain information to perform the installation of the water distribution system 211.

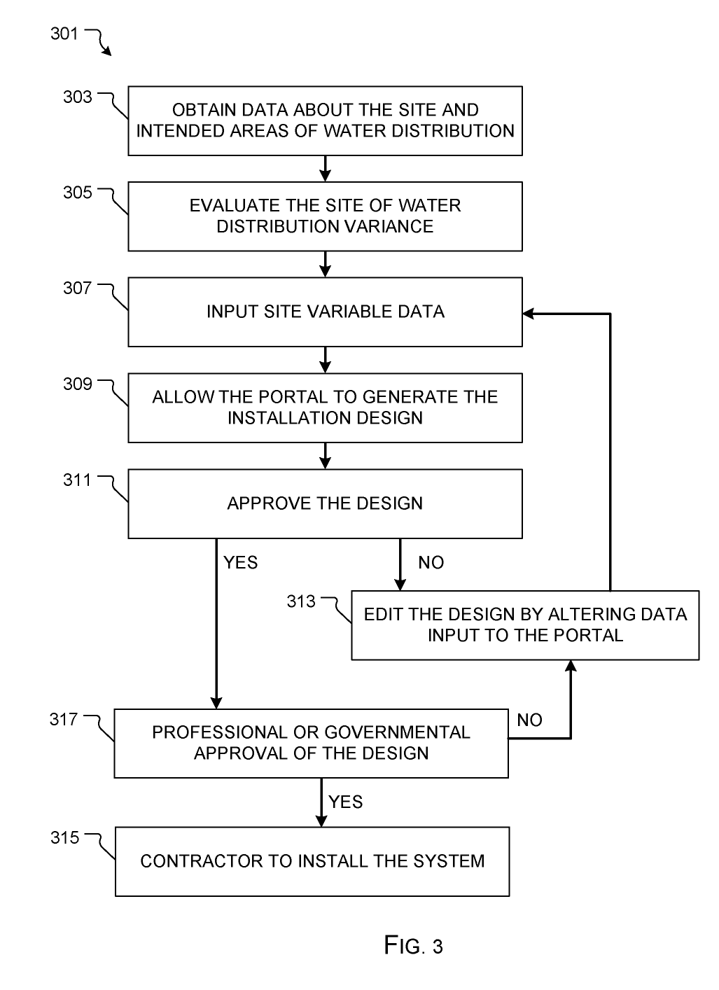

Referring now to FIG. 3 the preferred method of use of system 201 is depicted. Method 301 including obtaining the site data and watering areas 303, evaluating the site for water distribution variation 305, inputting site variable data 307, allow the portal to generate the installation design 309, approving the design 311, if not approved, editing the design 313 and if approved, installing the system by the contractor 315. It is also contemplated that additional professional or governmental approvals 317 could be required prior to the installation of the system and if needed revisions if rejected.

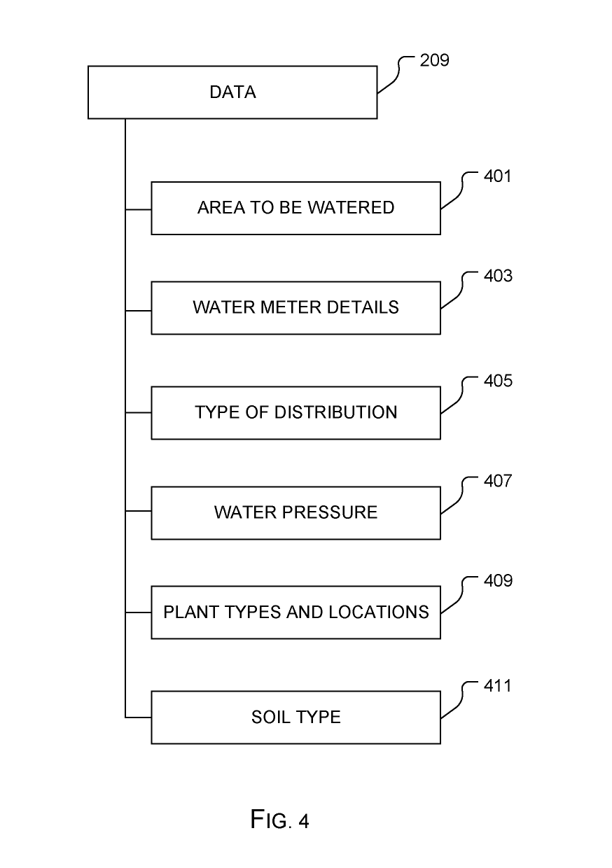

Examples of data 209 that would be input from the customer 215 or the contractor 213 are depicted by FIG. 4 including area to be watered 401, water meter details 403, type of distribution 405, water pressure 407, plant types and locations 409 or soil type 411. While these data types are depicted, they are given as examples and not intended to limit the scope of the invention. It is contemplated and will be understood that the data needed to generate a design will depend on the information required to define the area and its water distribution needs and possibilities.

It is further contemplated that tools such as satellite imagery, drone surveillance, public property records or the like could be used to obtain data needed by the system to define the area and its water distribution needs.

It is contemplated that the portal 207 with the corresponding CPU 203 or database 205 include equations 503, algorithms 505, data tables 507 and the like to enable the portal 207 to generate a design for the requested water distribution system 211 and its corresponding bill of materials 219.

It should be appreciated that one of the unique features believed characteristic of the present application is that portal 207, CPU 203 and database 205 enable those without engineering training to develop water distribution system designs or bill of materials 219.

Another unique feature believed characteristic of the present application is that the process of requesting and having a water distribution system installed is streamlined removing architectural consultants from the process to reduce the cost and complexity thereof.

The particular embodiments disclosed above are illustrative only, as the embodiments may be modified and practiced in different but equivalent manners apparent to those skilled in the art having the benefit of the teachings herein. It is therefore evident that the particular embodiments disclosed above may be altered or modified, and all such variations are considered within the scope and spirit of the application. Accordingly, the protection sought herein is as set forth in the description. Although the present embodiments are shown above, they are not limited to just these embodiments, but are amenable to various changes and modifications without departing from the spirit thereof.

What is claimed:

1. An automatic water distribution design generating system comprising:
at least one CPU with the ability to store data;
at least one portal in digital communication with the CPU;
the portal configured to allow requirements for a water distribution system to be entered therein;
wherein the portal is a tool that generates a water distribution system design and communicates with a contractor to perform the work.

2. The system of claim 1 wherein the portal or CPU contain equations, algorithms, data tables or the like to facilitate generating a water distribution system design.

3. The system of claim 1 wherein the water distribution system design includes a bill of materials.

4. The system of claim 1 wherein at least some of the requirements for a water distribution system are obtained via aerial or drone imagery.

5. The system of claim 1 wherein at least some of the requirements for a water distribution system are obtained via satellite imagery.

6. The system of claim 1 wherein at least some of the requirements for a water distribution system are obtained via public records.

7. The process of automating a water distribution system design given the system of claim 1, comprising:
obtaining the site data and watering areas;
evaluating the site for water distribution variation;
inputting site variable data;
allow the portal to generate the installation design;
approving the design;
if not approved, editing the design;
obtaining professional or governmental approval for the design;
if not approved, editing the design; or
if approved, installing the system.
